(19) United States
(12) Patent Application Publication
(10) Pub. No.: US 2014/0110926 A1
(43) Pub. Date: Apr. 24, 2014

(54) Photo Album Having Cascading Pages

(71) Applicant: Rebecca L. Senger, Helotes, TX (US)

(72) Inventor: Rebecca L. Senger, Helotes, TX (US)

(21) Appl. No.: 14/143,205

(22) Filed: Dec. 30, 2013

Related U.S. Application Data
(63) Continuation-in-part of application No. 13/847,755, filed on Mar. 20, 2013.
(60) Provisional application No. 61/649,925, filed on May 22, 2012.

(51) Int. Cl. B42D 1/08

(52) U.S. Cl. CPC B42D 1/08
USPC 281/22

(57) ABSTRACT

A cascading photo album includes a plurality of pages arranged in a stacked configuration, each page having opposed inner and outer edges. A binding member is coupled to respective inner edges such that the pages are movable between closed and open configurations. A plurality of insert sleeves is coupled to respective pages. The sleeves may be positioned in various configurations and intermingled with standard photo album contents. Each page includes a length between respective inner and outer edges that is different than a length between inner and outer edges of any other page. The length of each successively rearwardly adjacent page extends longer than a preceding page. The outer edge of each page is configured in the form of an alphabetic character. Together, the outer edges are arranged to form a word, mascot, personal name, or company name.

### CROSS REFERENCE TO RELATED APPLICATION

This application claims the benefit of non-provisional patent application Ser. No. 13/847,755 filed on Mar. 20, 2013 titled “Scrap Book Having Transparent Photo Sleeves,” which claims the benefit of provisional application Ser. No. 61/649,925 filed on May 22, 2012, titled “Scrap Book Having Transparent Photo Sleeves.”

### BACKGROUND OF THE INVENTION

This invention relates generally to the field of photo albums and, more particularly, to a photo album having a cascading configuration with each page including an outer edge indicative of an alphanumeric character and including one or more sleeves to receive photographs.

Photo albums are popular ways of organizing printed material related to one's experiences. Photo albums typically include a plurality of pages of identical size and configuration, each with several adjacently-arranged plastic sleeves into which photos may be inserted and remove inserted. Although assumably effective for their intended purposes, traditional photo albums are difficult to personalize—whether to reflect a person's name, a person's school mascot, or other means of identification with a school, company, family, or the like.

Therefore, it would be desirable to have a cascading photo album that may be purchased with an element of personalization or identification with a school, company, institution, or the like and that may also include sleeves into which photographs or other artifacts may be displayed and stored.

### SUMMARY OF THE INVENTION

Accordingly, the present invention pertains to a cascading photo album having a plurality of pages arranged in a stacked configuration, each page having opposed inner and outer edges. A binding member is coupled to respective inner edges such that the pages are movable between closed and open configurations. A plurality of insert sleeves is coupled to respective pages. The sleeves may be positioned in various configurations and intermingled with standard photo album contents. Each page includes a length between respective inner and outer edges that is different than a length between inner and outer edges of any other page. The length of each successively rearwardly adjacent page extends longer than a preceding page. The outer edge of each page is configured in the form of an alphabetic character. Together, the outer edges are arranged to form a word, mascot, personal name, or company name.

Therefore, an object of this invention is to provide a photo album having transparent sleeves for removably storing and displaying photographic prints.

Another object of this invention is to provide a photo album, as aforesaid, that protects photographic prints from damage when inserted into respective sleeves.

Still another object of this invention is to provide a photo album, as aforesaid, having a plurality of pages on which one or more transparent sleeves may be permanently mounted.

Additional features and advantages of the invention will be set forth in the description which follow, and will be apparent from the description, or may be learned by practice of the invention. The forgoing general description and the following detailed description are exemplary and explanatory and are intended to provide further explanation of the invention.

### BRIEF DESCRIPTION OF THE DRAWINGS

FIG. 1 is a perspective view a photo album having transparent sleeves according to one embodiment of the present invention; and

FIG. 2 is a perspective view of a photo album having transparent sleeves according to another embodiment of the present invention.

FIG. 3 is an exploded view of the photo album as in FIG. 1;

FIG. 4a is a top view of a transparent sleeve removed from the photo album as in FIG. 1;

FIG. 4b is a sectional view taken along line 4b-4b of FIG. 4a;

FIG. 4c is an isolated view on an enlarged scale taken from a portion of FIG. 4b;

FIG. 5 is a perspective view of a cascading photo album according to another embodiment of the present invention illustrated in a closed configuration;

FIG. 6 is another perspective view of the cascading photo album as in FIG. 5 with a first page in an open configuration;

FIG. 7 is another perspective view of the cascading photo album as in FIG. 5 with first and second pages in an open configuration;

FIG. 8 is another perspective view of the cascading photo album as in FIG. 5 with first, second, and third pages in an open configuration;

FIG. 9 is another perspective view of the cascading photo album as in FIG. 5 with the first four pages in an open configuration;

FIG. 10 is another perspective view of the cascading photo album as in FIG. 5 illustrated in a fully opened configuration;

FIG. 11 is a perspective view of the cascading photo album as in FIG. 10 illustrating photographs being inserted into respective transparent insert sleeves;

FIG. 12 is a perspective view of the cascading photo album as in FIG. 11 with the photographs fully positioned in respective transparent insert sleeves; and

FIG. 13 is a perspective view of the cascading photo album with the plurality of pages being cascaded or partially opened.

### DETAILED DESCRIPTION OF THE INVENTION

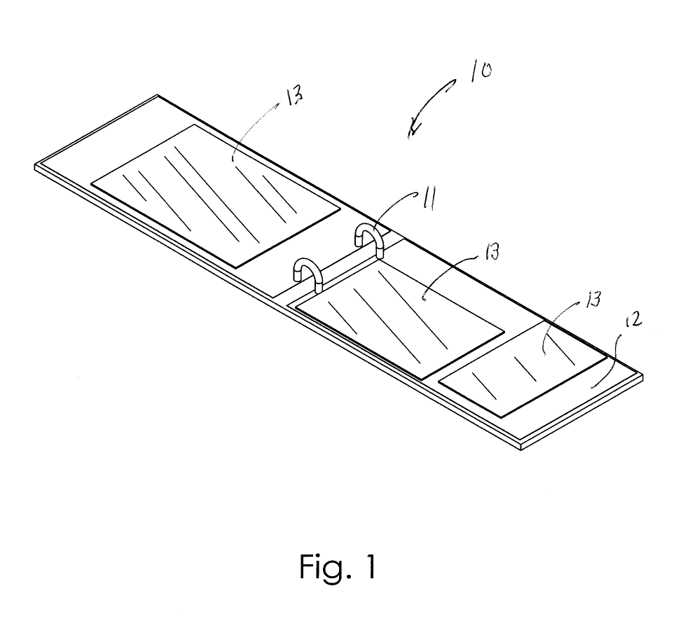

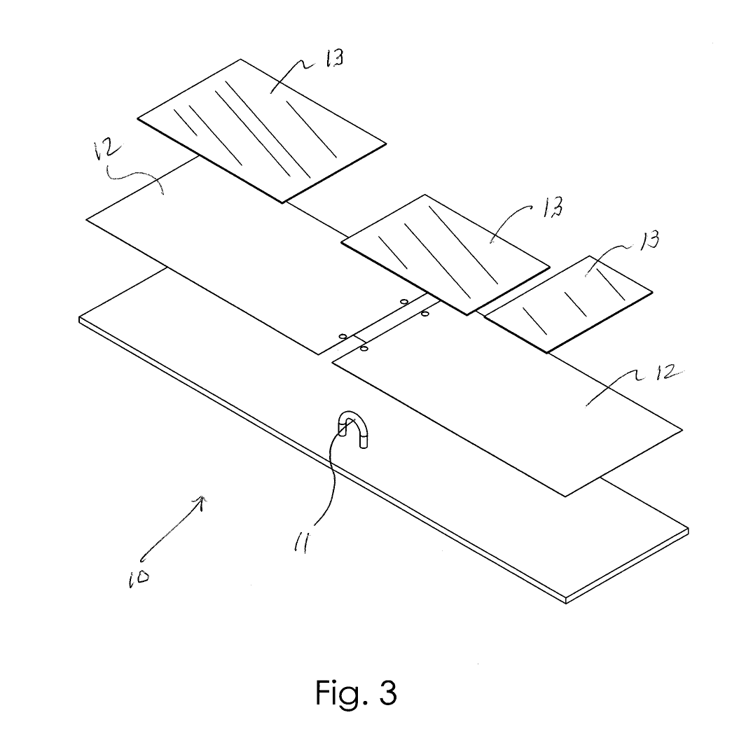

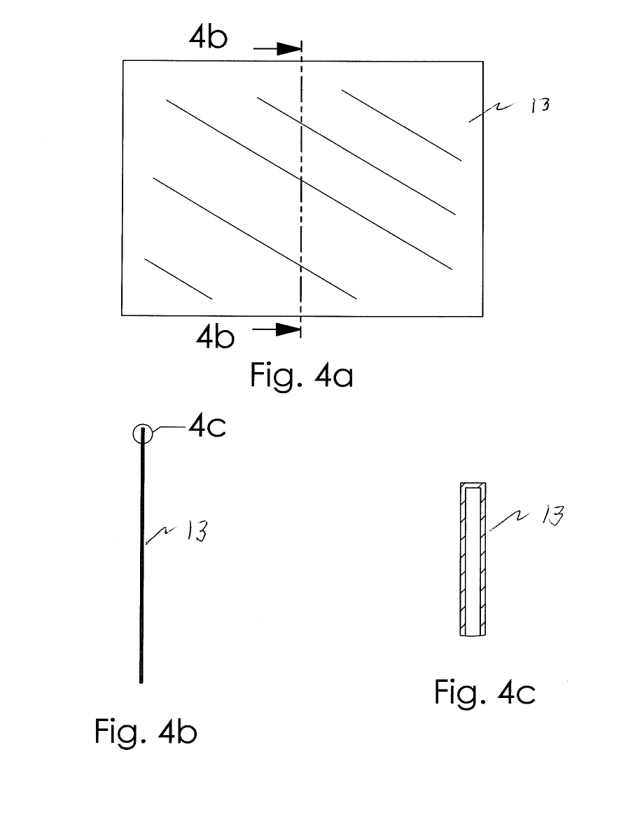

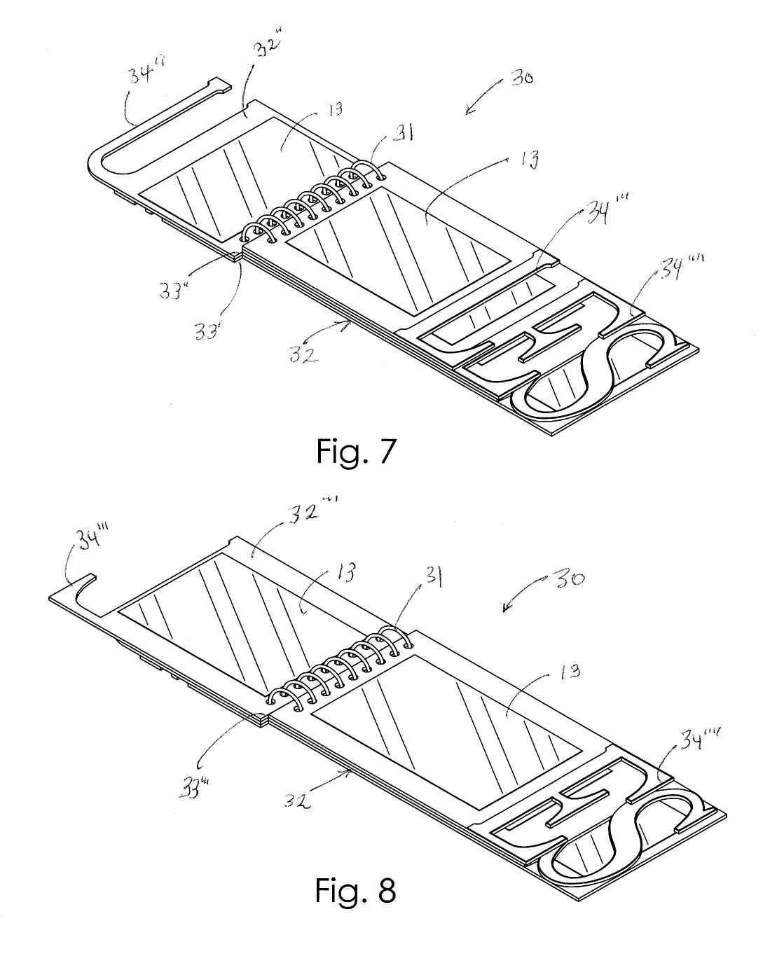

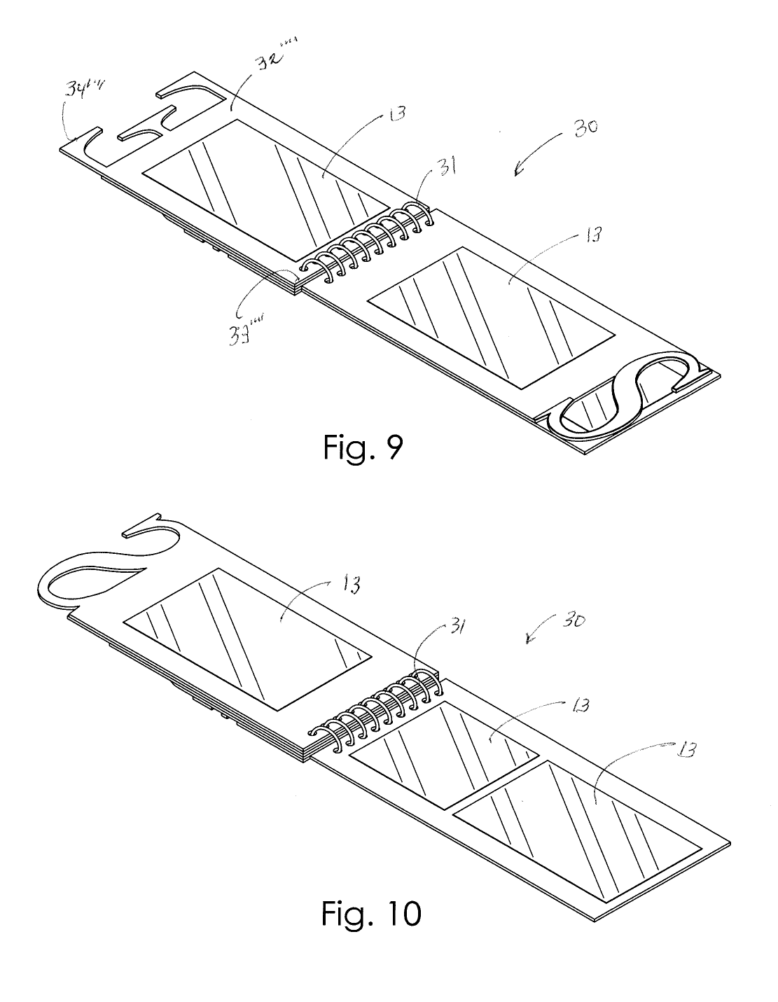

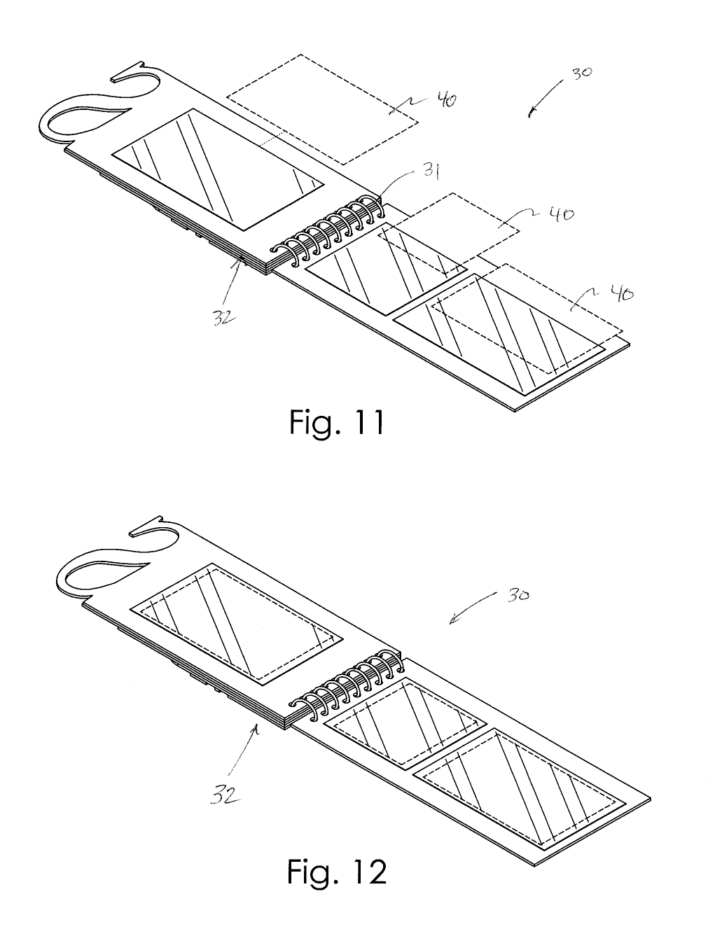

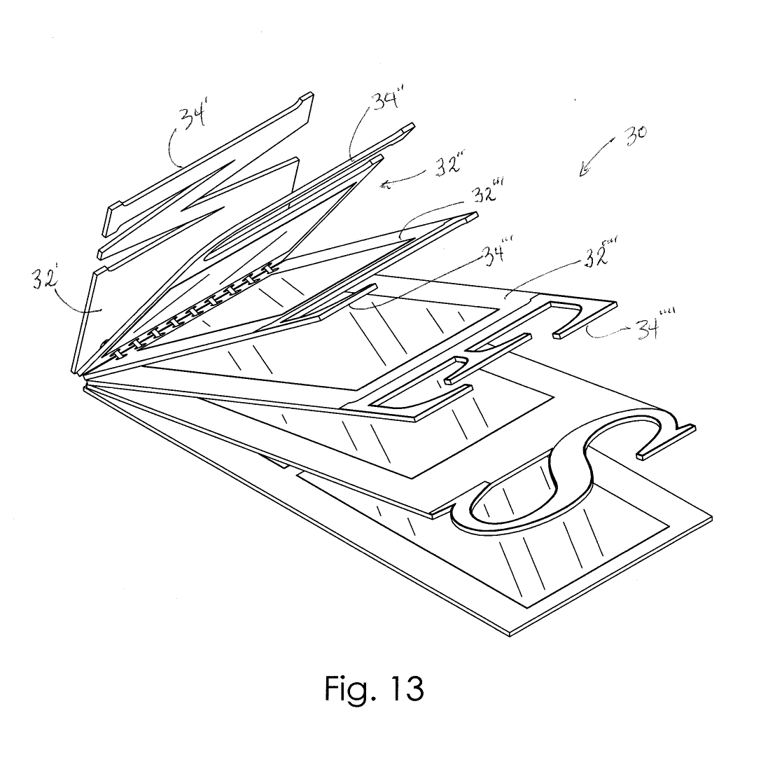

A photo album having one or more transparent sleeves according to the present invention will now be described in detail with reference to FIGS. 1 to 13 of the accompanying drawings.

FIG. 1 illustrates a first exemplary embodiment of the invention. In the first exemplary embodiment, a photo album 10 is provided having a plurality of pages 12 arranged in a stacked arrangement which are flexibly affixed to a binding member 11. Each page may include a side edge that may be secured by the binding member. The binding member 11 according to the first exemplary embodiment may include a two-ring binding system from which pages may be selectively added or removed although other embodiments may include a 3-ring binding system or other book-binding methods. The pages 12 are shown as rectangular although other configurations would also be suitable. Preferably, the pages are constructed of a heavy paper material although other materials may also work. Each page has a generally thin planar configuration having opposed upper and lower surfaces.

The photo album 10 may include a plurality of transparent insert sleeves 13 attached to the pages 12. Each page may include a plurality of insert sleeves 13 spaced apart from one another although some pages may include no sleeves at all. Respective sleeves may be attached to upper surfaces of respective pages or to both upper and lower surfaces. The insert sleeves 13 are shown as rectangular and mounted with their corners in alignment with those of the page 12; however these alignment details are not requirements. Portions of each page 12 that are not covered by a sleeve 13 may be used to support and retain content for which a protective sleeve is not needed. Sleeves 13 may be mounted with adhesive either at the point of manufacture or by a user.

Referring still to the first exemplary embodiment shown in FIG. 1, the sleeves 13 themselves are preferably made of a transparent and flexible plastic film material. The sleeves 13 may be affixed to the page 12 using an adhesive or other fastening means. The sleeves 13 generally include at least one sheet of material that may be affixed to the page on three of its four sides and a second sheet overlaying the first. The first and second sheets of each insert sleeve 13 together define an open interior area and an open end through which a flat item of a complementary size or shape may be inserted. In other words, the sheets may be coupled together on 3 out of 4 sides. Where two or more sheets of material are provided to form the sleeve 13, the rearmost sheet may be secured directly to the page 13 throughout its entire area. In addition to being manufactured as a part of pages in a photo album or for insertion into a photo album the sleeves 13 may be manufactured and provided in conjunction with an adhesive such that the user may place the sleeves 13 at any desired location in the photo album.

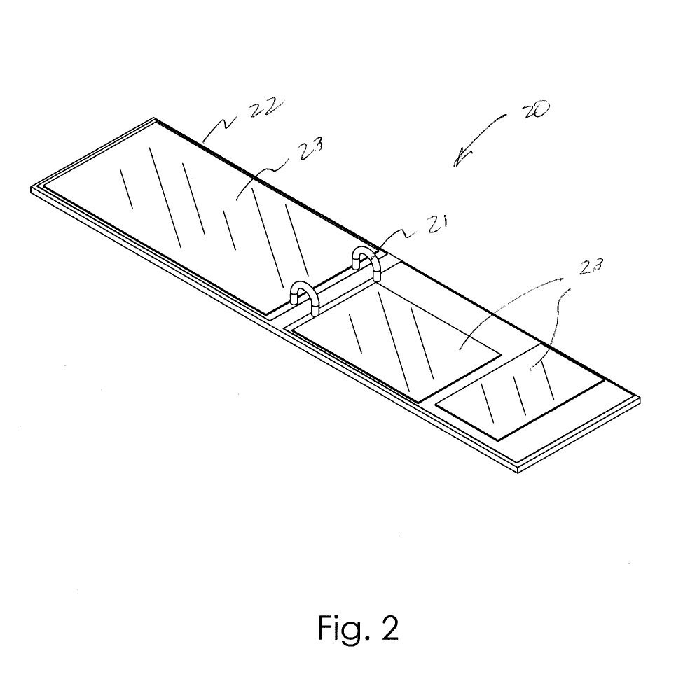

FIG. 2 shows a photo album 20 according to a second exemplary embodiment includes a binding 21 and a plurality of pages 22 having a construction substantially similar to the photo album 10 described above. The photo album 20 includes a plurality of insert sleeves 23, each sleeve 23 having a configuration that covers substantially all of the surface area of a respective page 22. Other ornamental materials associated with the contents of the sleeve 23 may be omitted or placed on a facing page, such as ribbons, stars, logo's, mascot images, or the like.

In use, treasured photographic prints may be selectively and removably preserved within respective sleeves 13 in the photo album 10 without damage or permanent attachment. It is understood that other articles of personal significance to a user may be affixed to respective surfaces of respective pages adjacent respective insert sleeves 13.

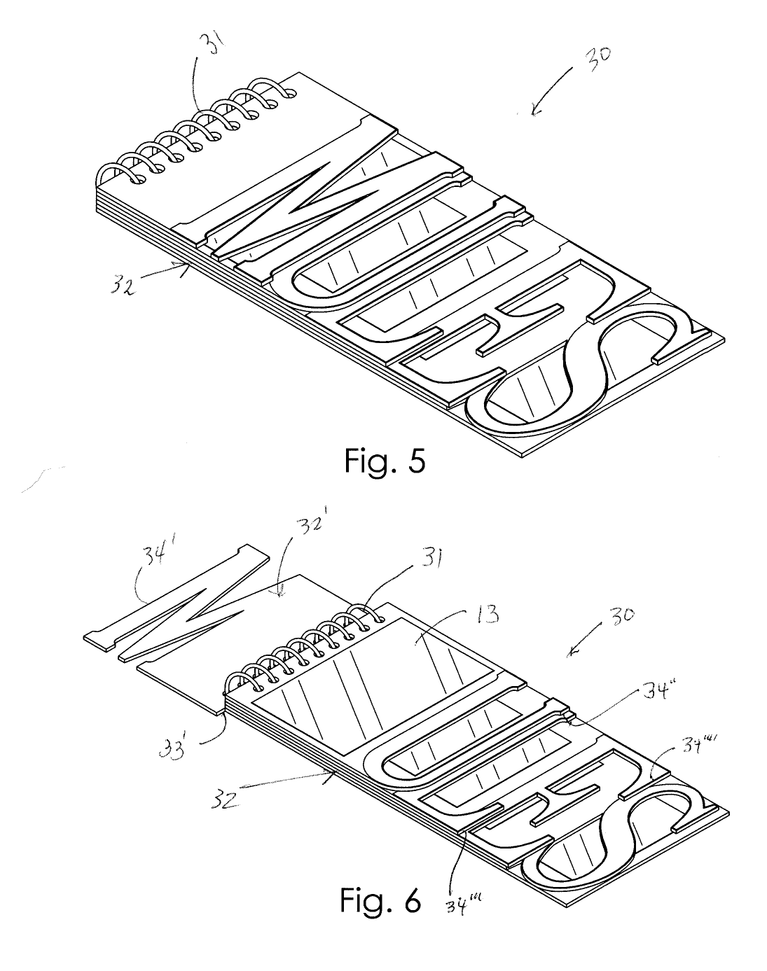

FIGS. 5 to 13 show a photo album 30 according to another exemplary embodiment that includes a binding 31 and a plurality of pages 32 having a construction substantially similar to the photo album 10 described above except as specifically noted below. Each page 32 includes an inner edge pivotally coupled to a binding member 31 such that the pages are selectively movable between various open FIGS. 6-12) and closed (FIG. 5) configurations. Each page also includes an outer edge opposite its corresponding inner edge. Opposed upper and lower edges extend between respective inner and outer edges. Specific reference numerals will be assigned below with reference to specific pages of the plurality of pages.

The photo album 30 according to this embodiment is also referred to as a cascading photo album or as a photo album having cascading letters. Each succeeding page of the plurality of pages has a length between respective inner and outer edges that is different than the length of any other page. More particularly, each successive page extends longer from the binding member 31 than does the immediately preceding page. Stated still another way, the length between respective inner and outer edges of a successor page is longer than the length of the preceding pages. In this way, the outer edges of all of the plurality of pages are viewable when the photo album 30 is completely closed (FIG. 5).

The plurality of pages 32 will now be described specifically, using primed reference numerals for otherwise identical structures. The exemplary embodiment of a cascading photo album 30 will be described herein as having four pages. Accordingly, a first page 32′ includes a first page inner edge 33′ pivotally coupled to the binder member 31—which, in this embodiment, is a spiral binder. The first page 32′ also includes an opposed outer edge 34′. Each outer edge includes a shape configuration indicative of an alphabetic letter as will be described in more detail later. The first page 32′ defines a length between the first page inner edge 33′ and the first page outer edge 34′.

A second page 32″ includes a second page inner edge 33″ pivotally coupled to the binder member 31 and includes an outer edge 34″. The second page 32″ defines a length between the second page inner edge 34″ and the second page outer edge″ that is longer than the length between the first page inner edge 33′ and the first page outer edge 34′. Therefore, the outer end 34″ is visible to a user even when both the first and second pages are in a closed configuration (FIG. 5). For sake of clarity, the second page 32″ is considered immediately and rearwardly adjacent to the first page 32′.

Similarly, a third page 32′″ includes a third page inner edge 33′″ pivotally coupled to the binder member 31 and includes an outer edge 34′″. The third page 32′″ defines a length between the third page inner edge 34′″ and the third page outer edge′″ that is longer than the length between the second page inner edge 33″ and the second page outer edge 34″. Therefore, the outer end 34″′ is visible to a user even when both the first, second, and third pages are in a closed configuration (FIG. 5). For sake of clarity, the third page 32″′ is considered immediately and rearwardly adjacent to the second page 32″.

In the same manner, a fourth page 32″″ includes a fourth page inner edge 33″″ pivotally coupled to the binder member 31 and includes an outer edge 34″″. The fourth page 32″″ defines a length between the fourth page inner edge 34″″ and the fourth page outer edge″″ that is longer than the length between the third page inner edge 33′″ and the third page outer edge 34′″. Therefore, the outer end 34;′″ is visible to a user even when both the first, second, and third pages are in a closed configuration (FIG. 5). For sake of clarity, the fourth page 32″″ is considered immediately and rearwardly adjacent to the third page 32″′.

A similar description could be continued for a photo album 30 having five or more pages. This “cascading” effect is best illustrated in FIG. 13.

Now with more specific attention to the configuration of the outer edge of each page, each outer edge is configured in the shape of an alphabetic letter or associated character. Each letter extends between a respective upper edge and a respective lower edge. Importantly, the pages 32 are arranged in a predetermined order such that the outer edges—and the associated alphabetic characters—spell the name of a person's name, school mascot, association, business entity, or the like. Because of the differing page lengths, as described above, the entire word can be seen when all pages are in the closed configuration FIG. 5), whereas one letter from left to right is displaced as each page is pivoted to the open configuration (FIGS. 6 to 9).

In use, the cascading photo album 30 shown in FIGS. 5 to 13 is partially personalized at the point of manufacture and is partially personalized by a consumer. For instance, the photo album 30 shown in the drawings is initially personalized to indicate the “MULES” school mascot. The M-U-L-E-S letters are coupled to or integrally constructed with respective outer edges of respective pages and are all viewable at the completely closed configuration. Each page of the photo album 30 may include one or more transparent sleeves 13 configured to receive a photograph 40.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method and examples, but by all embodiments and methods within the scope and spirit of the invention.

1. A cascading photo album for use in removably holding and displaying photographs, comprising:
a plurality of pages arranged in a generally stacked configuration, each page having opposed upper and lower surfaces, an inner edge, and an outer edge;
a binding member coupled to respective inner edges of said plurality of pages such that each page is pivotally movable between open and closed configurations; and
a plurality of insert sleeves coupled to selected pages of said plurality of pages;
wherein:
each page of said plurality of pages includes a length between respective inner and respective outer edges that is different than a length between respective inner and respective outer edges of any other page of said plurality of payments;
each outer edge of a respective page of said plurality of pages includes a configuration indicative of an alphabetic character.

2. The cascading photo album as in claim 1, wherein said plurality of pages includes:
a first page having a first page inner edge pivotally coupled to said binding member and having an opposed first page outer edge, said first page defining a first length between said first page inner edge and said first page outer edge; and
a second page rearwardly adjacent said first page having a second page inner edge pivotally coupled to said binding member and having a second page outer end, said second page defining a length between said second page inner edge and said second page outer edge that is longer than said length between said first page inner edge and said first page outer edge.

3. The cascading photo album as in claim 2, wherein said plurality of pages includes:
a third page rearwardly adjacent said second page having a third page inner edge pivotally coupled to said binding member and having an opposed third page outer edge, said third page defining a first length between said third page inner edge and said third page outer edge that is longer than said length between said second page inner edge and said second page outer edge; and
a fourth page rearwardly adjacent said third page having a fourth page inner edge pivotally coupled to said binding member and having a fourth page outer end, said fourth page defining a length between said fourth page inner edge and said fourth page outer edge that is longer than said length between said third page inner edge and said third page outer edge.

4. The cascading photo album as in claim 3, wherein said respective outer edges of said first, second, third, and fourth pages are sequentially arranged to form a name of a person, team mascot, association, or company.

5. The cascading photo album as in claim 1, wherein said respective outer edges of said plurality of pages are sequentially arranged to form a name of a person, team mascot, association, or company.

6. The cascading photo album as in claim 1, wherein:
each page of said plurality of pages includes opposed upper and lower edges extending between respective inner and outer edges; and
said respective outer edges indicative of an alphabetic character extend between said upper and lower edges.

7. The cascading photo album as in claim 1, wherein each of said plurality of insert sleeves includes:
a first layer of plastic material having a generally rectangular configuration; and
a second layer of plastic material having a generally rectangular configuration and overlaying said first layer, said first and second layers being coupled on three of four side edges so as to define an interior area and an opening configured to receive a photograph into said interior area.

8. The cascading photo album as in claim 7, wherein said first layer of a respective insert sleeve includes a bottom surface adhesively coupled to a respective page.

9. The cascading photo album as in claim 7, wherein respective first layers of said respective insert sleeves are constructed of a generally transparent material so that articles situated in said interior area of said respective insert sleeves are visible from outside said respective insert sleeves.

10. The cascading photo album as in claim 7, wherein said respective insert sleeves are coupled to said upper surfaces of respective pages.

11. The cascading photo album as in claim 10, wherein said respective insert sleeves are coupled to said lower surfaces of respective pages.

12. The cascading photo album as in claim 7, wherein a subset of said plurality of insert sleeves may be positioned on a respective single page such that no two of said subset of said plurality of insert sleeves contact one another.

13. The cascading photo album as in claim 12, wherein said subset of said plurality of insert sleeves covers substantially less than an entirety of said respective single page.

14. The cascading photo album as in claim 12, wherein a single insert sleeve is coupled to a respective page and covers substantially an entire surface area of said respective page.

15. The cascading photo album as in claim 1, wherein said binding member includes a spiral binder system to which said plurality of pages are permanently attached.

16. The cascading photo album as in claim 1, wherein said binding member includes a 2-ring binder system from which pages may be selectively added or removed.

17. The cascading photo album as in claim 5, wherein the quantity of said plurality of pages is equal to a number of letters to form the name of a person, team mascot, association, or company.
